(19) United States
(12) Patent Application Publication
(10) Pub. No.: US 2026/0339885 A1
(43) Pub. Date: Oct. 29, 2026

(54) METHODS AND SYSTEMS FOR APPLYING RETENTION REQUIREMENTS TO ARCHIVED CONTENT

(71) Applicant: Box, Inc., Redwood City, CA (US)

(72) Inventors: Krishnaiah Gogineni, Pleasanton, CA (US); Alam Karim, Redwood City, CA (US); Nicklaus Torrecillas, Concord, CA (US); Ben Robbins, San Francisco, CA (US); Will Carlson, Glenview, IL (US)

(21) Appl. No.: 19/187,665

(22) Filed: Apr. 23, 2025

(51) Int. Cl. G06F 16/11; G06F 16/185

(52) U.S. Cl. CPC G06F 16/113; G06F 16/185

(57) ABSTRACT

Embodiments of the present disclosure are directed to archiving content items of a cloud-based collaboration environment. According to one embodiment, a method for applying governance to archived content in a cloud-based collaboration environment can comprise receiving a request to apply retention to a set of content items, wherein the set of content items are stored in an archive, identifying the set of content items or a user associated with the set of content, and applying one or more retention markers based on the identified set of content items or a user associated with the set of content.

### FIELD OF THE DISCLOSURE

Embodiments of the present disclosure relate generally to methods and systems for managing a cloud-based collaboration environment and more particularly to archiving content items of a cloud-based collaboration environment.

### BRIEF SUMMARY

Embodiments of the present disclosure are directed to archiving content items of a cloud-based collaboration environment. According to one embodiment, a method for applying governance to archived content in a cloud-based collaboration environment can comprise receiving a request to apply retention to a set of content items, wherein the set of content items are stored in an archive, identifying the set of content items or a user associated with the set of content, and applying one or more retention markers based on the identified set of content items or a user associated with the set of content.

According to one aspect, the request to apply retention to the set of content items can identify a user and identifying each content item of the set of content items can comprise identifying content items in the archive previously owned by the identified user.

According to one aspect, the method can further comprise defining a retention policy related to the user and applying a retention marker to the user.

According to one aspect, the request to apply retention to the set of content items can identify a content item by name.

According to one aspect, content items can be stored in the archive in a hierarchical arrangement and identifying each content item of the set of content items can comprise traversing the hierarchy of content items in the cloud-based collaboration environment to locate all subfolders can content items therein.

According to one aspect, the method can further comprise detecting an activity on a content item of the collaboration environment and determining whether to apply a retention policy based on the detected activity.

According to one aspect, the method can further comprise in response to determining to apply the retention policy, applying the retention policy, determining whether to retain the content item based on the applied retention policy, and in response to determining to retain the content, copying preventing the requested activity.

According to another embodiment, a system can comprise a processor and a memory coupled with and readable by the processor and storing therein a set of instructions which, when executed by the processor, causes the processor to receive a request to apply retention to a set of content items, wherein the set of content items are stored in an archive, identify the set of content items or a user associated with the set of content, and apply one or more retention markers based on the identified set of content items or a user associated with the set of content.

According to one aspect, the request to apply retention to the set of content items can identify a user and identifying each content item of the set of content items can comprise identifying content items in the archive previously owned by the identified user.

According to one aspect, the instructions can further cause the processor to define a retention policy related to the user and applying a retention marker to the user.

According to one aspect, request to apply retention to the set of content items can identify a content item by name.

According to one aspect, content items can stored in the archive in a hierarchical arrangement and identifying each content item of the set of content items can comprise traversing the hierarchy of content items in the cloud-based collaboration environment to locate all subfolders can content items therein.

According to one aspect, the instructions can further cause the processor to detect an activity on a content item of the collaboration environment and determine whether to apply a retention policy based on the detected activity.

According to one aspect, the instructions can further cause the processor to in response to determining to apply the retention policy, apply the retention policy, determine whether to retain the content item based on the applied retention policy, and in response to determining to retain the content, prevent the requested activity.

According to yet another embodiment, a non-transitory, computer-readable medium comprising a set of instructions stored therein which, when executed by a processor, causes the processor to receive a request to apply retention to a set of content items, wherein the set of content items are stored in an archive, identify the set of content items or a user associated with the set of content, and apply one or more retention markers based on the identified set of content items or a user associated with the set of content.

According to one aspect, the request to apply retention to the set of content items identify a user and identifying each content item of the set of content items can comprise identifying content items in the archive previously owned by the identified user and wherein the instructions further cause the processor to define a retention policy related to the user and applying a retention marker to the user.

According to one aspect, the request to apply retention to the set of content items can identify a content item by name.

According to one aspect, content items can be stored in the archive in a hierarchical arrangement and identifying each content item of the set of content items can comprise traversing the hierarchy of content items in the cloud-based collaboration environment to locate all subfolders can content items therein.

According to one aspect, the instructions can further cause the processor to detect an activity on a content item of the collaboration environment and determine whether to apply a retention policy based on the detected activity.

According to one aspect, the instructions further cause the processor to in response to determining to apply the retention policy, apply the retention policy, determine whether to retain the content item based on the applied retention policy, and in response to determining to retain the content, prevent the requested activity.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary environment in which embodiments of the present disclosure may be implemented.

FIG. 4 is a block diagram illustrating additional details of an architecture for archiving collaboration environment content according to one embodiment of the present disclosure.

FIG. 5 is a flowchart illustrating an exemplary process for creating an archive according to one embodiment of the present disclosure.

FIG. 6 is a flowchart illustrating an exemplary process for archiving content according to one embodiment of the present disclosure.

FIG. 7 is a flowchart illustrating an exemplary process for restoring content from an archive to a collaboration environment according to one embodiment of the present disclosure.

FIG. 8 is a flowchart illustrating an exemplary process for deleting an archive according to one embodiment of the present disclosure.

FIG. 9 is a flowchart illustrating an exemplary process for applying governance to archived content according to one embodiment of the present disclosure.

FIG. 10 is a flowchart illustrating an exemplary process for retaining currently owned content according to one embodiment of the present disclosure.

FIG. 11 is a flowchart illustrating an exemplary process for retaining previously owned content according to one embodiment of the present disclosure.

FIG. 12 is a flowchart illustrating an exemplary process for applying an activity-based legal hold on archived content according to one embodiment of the present disclosure.

FIG. 13 is a flowchart illustrating an exemplary process for enforcement of retention according to one embodiment of the present disclosure.

FIG. 14 is a flowchart illustrating an exemplary process for removing a legal hold according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably. The term “automatic” and variations thereof, as used herein, refers to any process or operation done without material human input when the process or operation is performed.

However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM) , or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM) , a Programmable Read-Only Memory (PROM) , and Erasable Programable Read-Only Memory (EPROM) , a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an A SIC or other integrated circuit, a digital signal processor, a hard-wired electronic or logic circuit such as discrete element circuit, a programmable logic device or gate array such as Programmable Logic Device (PLD), Programmable Logic Array (PLA) , Field Programmable Gate Array (FPGA) , Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon ® 610 and 615 with 4G LTE Integration and 64-bit computing, A pple® A 7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core i5-4670K and i7-4770K 22 nm Haswell, Intel ® Core® i5-3570K 22 nm Ivy Bridge, the AMD® FX™ family of processors, AMD® FX-4300, FX-6300, and FX-8350 32nm Vishera, AM D® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

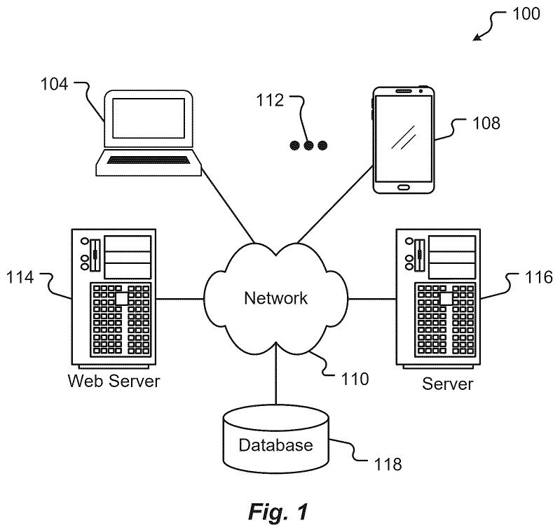

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA) , Internetwork Packet Exchange (IPX) , AppleTalk, and the like.

Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

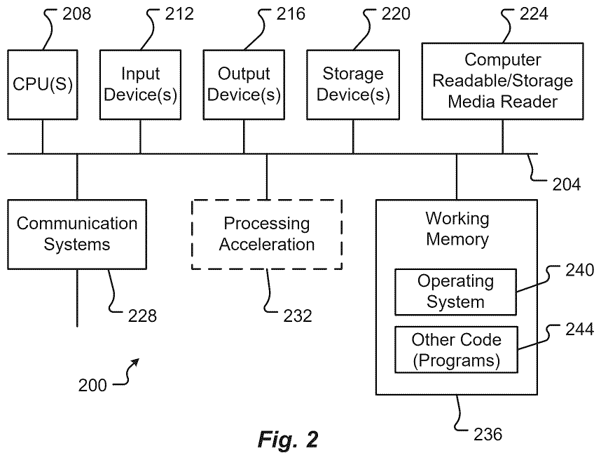

FIG. 2 is a block diagram illustrating elements of an exemplary computing device in which embodiments of the present disclosure may be implemented. M ore specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM) , which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A 7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i 5-4670K and 7-4770K 22 nm Haswell, Intel® Core® i5-3570K 22 nm Ivy Bridge, the AMD® FXTM family of processors, AMD® FX-4300, FX-6300, and FX-8350 32 nm Vishera, AM D® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM 926EJ-STM processors, other industry-equivalent processors, and may perform computational functions using any known or future-developed standard, instruction set, libraries, and/or architecture.

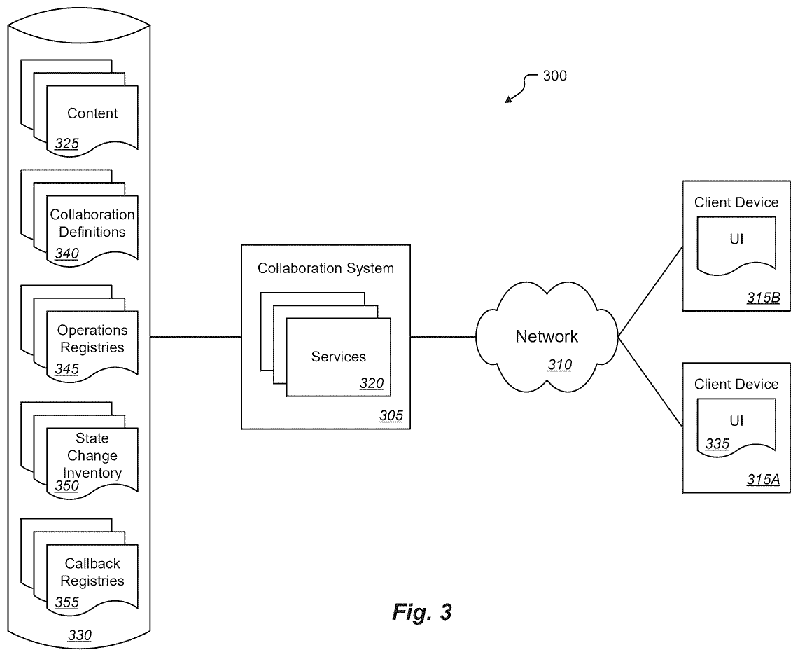

FIG. 3 is a block diagram illustrating an exemplary environment in which embodiments of the present disclosure may be implemented. As illustrated in this example, the environment 300 can comprise a cloud-based collaboration system 305 coupled with a communication network 310. The collaboration system 305 can comprise any one or more servers and/or other computing devices as described above. The communication network 310 can comprise any one or more wired and/or wireless, local-area and/or wide-area networks as described above including, but not limited to, the Internet.

Also coupled with the communication network 310 can be any number of client devices 315A and 315B. The client devices 315A and 315B can comprise one or more personal computers, laptop computers, tablets, smartphones, and/or other computing devices as described above. Generally speaking, the client devices 315A and 315B can access services 320 of the collaboration system 305 via the communications network 320. Services 320 of the collaboration system 305, as will be described in greater detail below, provide for the storage of and access to content 325 such as files and/or folders in a repository 330. Additionally, or alternatively, the content 325 can comprise forms, Artificial Intelligence (AI) prompts, metadata and/or other types of information. To facilitate access to and interaction with the services 320, the collaboration system 305 can provide a user interface 335. The user interface 335 can comprise any graphical, textual, or combination thereof interface including, but not limited to, one or more webpages to be rendered on the client devices 315A and 315B.

According to one embodiment, one or more services 320 of the collaboration system 305 can provide for archiving of content items 325 of the collaboration environment 300. Generally speaking, and as will be described in greater detail below, the services 320 can periodically, on demand, or upon the occurrence of a predefined event, move content items 325, such as files and folders, from being active content available in the collaboration environment for authorized users to share to being archived content. However, this change does not move the archived content 325 out of storage 330 or to a different storage. Rather, archiving is achieved by changing ownership of the content 325. As noted, archiving can be initiated upon request. For example, an administrator user, through a user interface 335 of a client device 315 may identify certain content, e.g., by name, by associated user, etc., to be archived. Additionally, or alternatively, archiving can be initiated periodically or upon the occurrence of a predefined event. For example, archiving can be initiated based on a policy defining a time period of inactivity on a content item after which the content item should be archived.

Other information related to the content can be maintained in storage 330 by the collaboration system 305. For example, this other information can include, but is not limited to, collaboration definitions 340 defining user collaborations on content 325, operations registries 345 of logging operations performed on content 345, state change inventories 350 tracking a state of content 350, callback registries 355 storing callback functions related to content 325. Generally speaking, this additional information can be saved or backed up by the services 320 when content 325 is placed into archive thereby preserving pre-archive conditions for the content 320 allowing the content 325 to later be recovered or moved out of archive into again being active content in the collaboration environment. Restoration of content from archive can be initiated upon request. For example, an administrator user, through a user interface 335 of a client device 315 may identify certain archived content to be archived.

While archived, the content 325 is inaccessible for previous collaborators and is immutable. However, according to one embodiment, the archived content can be search and appear in search results for users of the collaboration system 305. In such cases, archived content can be indicated as such when the search results are presented. Additionally, or alternatively, governance can be applied to archived content items. As will be described in greater detail below, retention policies can be defined for and applied to archived content. Governance can additionally, or alternatively, include defining and enforcing legal holds on content associated with a particular user, e.g., based on actual or potential litigation or other legal action related to that user. According to one embodiment, and as will be described, the legal hold on archived content can be based on activity of the user. More specifically, the hold can be applied to archived content the user interacted with previously.

Generally speaking, and as will be described in greater detail below, the services 320 can periodically, on demand, or upon the occurrence of a predefined event, remove or delete archived content items 325. For example, an administrator user, through a user interface 335 of a client device 315 may identify certain content, e.g., by name, by associated user, etc., to be removed from archive. In another example, remove or deletion of archived content can be initiated based on a policy defining a time period after which archived content should be removed or deleted. In either case, removal or deletion of archived content can be subject to any retention policy or legal hold applied to that content. According to one embodiment, once removed from archive, the content item is no longer available on the collaboration system 305 and is not recoverable.

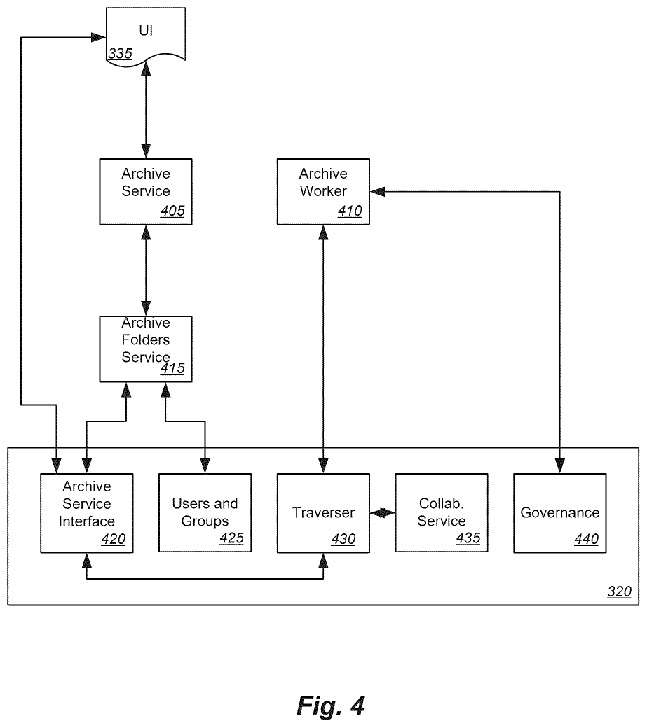

FIG. 4 is a block diagram illustrating additional details of an architecture for archiving collaboration environment content according to one embodiment of the present disclosure. As illustrated here, the collaboration system 305 described above can provide a number of services 320 that together perform the functions described herein to archive content of the collaboration environment. More specifically, the collaboration system 405 can provide an archive service 405 accessible through a user interface 335 as described above. Generally speaking, the archive service can receive user request through the user interface 335, process the requests in combination with the other services, and provide response through the user interface 335. An archive work 410 can also be executed by the collaboration system 305 to process asynchronous processes not initiated by a user. The archive service 405 can interact with an archive folder service 415. Generally speaking, the archive folder service 415 can create archive folders to represent an archive as will be described below.

Other services 320 can comprise an archive service interface 420, a users and groups service 425, a traverser service 430, a collaboration service 435, and a governance service 440. The archive service interface 420 can provide an interface between the archive folder service 415 and an underlying file system of the collaboration system to support read/write of content items and enforce permissions on content items. The users and groups service 425 can create an internal platform user. As will be described below, the internal platform user will be an owner of an archive folder created by the archive folder service 415. The traverser service 430 can provide support in finding related content items in a hierarchy of content items, e.g., a hierarchy of folders, subfolder, and files, when content is archived or restored. The collaboration service 435 can perform deletion and re-creation of user collaborations on content items when they are archived or restored as will be described below. The governance service 440 can perform a variety of functions as will be described below to manage content items, including archived content items. These functions can include, but are not limited to defining and enforcing retention policies, defining and enforcing legal holds, etc.

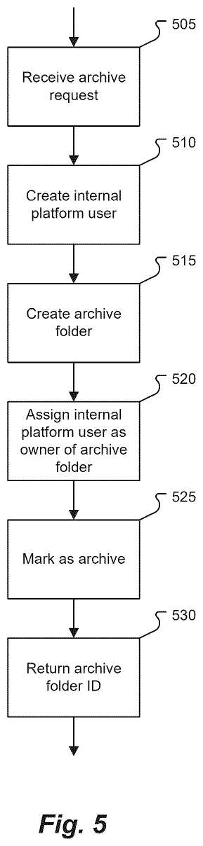

FIG. 5 is a flowchart illustrating an exemplary process for creating an archive according to one embodiment of the present disclosure. As illustrated in this example, archiving content items of a cloud-based collaboration environment can begin with receiving 505 a request to create an archive. For example, the request can be received through an administrator user interface. In another example, the request can be generated and received automatically based on an archiving policy. Such a policy may define, for example, a period of inactivity after which a content item should be moved to archive.

An internal platform user can be created 510. The internal platform user is not associated with an actual user of the cloud-based collaboration environment. However, the internal platform user can serve as an owner of content within the cloud-based collaboration environment or archive. According to one embodiment, the internal platform user may be assigned only read permissions on content in the collaboration environment or archive

An archive folder associated with an archive folder identifier can be created 515. The archive folder can comprise a container for archived content, i.e., content moved from the collaboration environment to the archive. The internal platform user can be assigned 520 as an owner of the archive folder and the archive folder can be marked 525 as an archive. According to one embodiment, folders marked as an archive and content items within folders marked as archive can be viewable and searchable but can be immutable. The archive folder identifier can be returned 530 in response to the request to create an archive

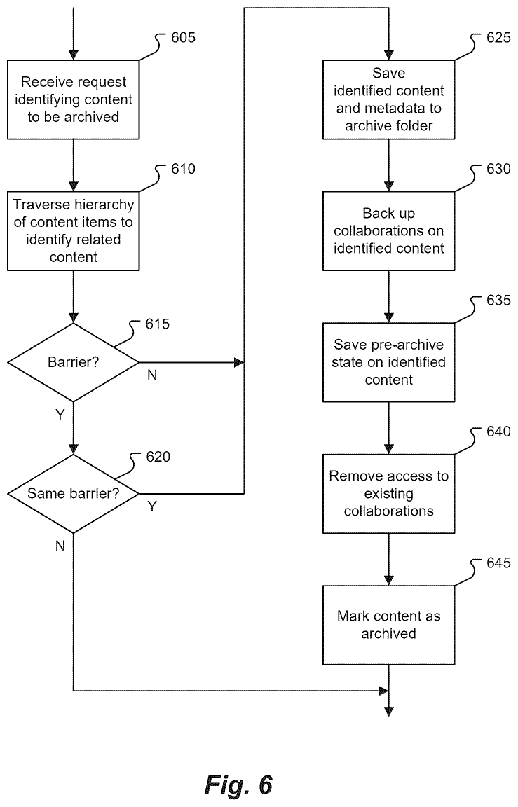

FIG. 6 is a flowchart illustrating an exemplary process for archiving content according to one embodiment of the present disclosure. As illustrated in this example, archiving content items of a cloud-based collaboration environment can further comprise receiving 605 a request to archive a set of content items of the cloud-based collaboration environment, i.e., to place the set of content items into an archive folder. The request can identify the set of content items and the archive folder. For example, the set of content items can be identified by one or more folder names or identifiers which the archive folder can be identified by the archive folder identifier assigned then the archive folder was created as described above.

As noted above, content items in the collaboration environment can be stored in a hierarchical manner, e.g., as hierarchically nested files and folders. Accordingly, content items in the set of content items can be located. This can be performed by traversing the hierarchy of content items in the cloud-based collaboration environment to locate all subfolders can content items therein.

According to one embodiment, content within the collaboration environment may be subject to information barriers to prevent to unintended sharing of content items between unrelated entities. Similarly, an archive can be segmented or unsegmented. A segmented archive can be subject to information barriers while an unsegmented archive is not. Accordingly, a determination 615 can be made as to whether the set of content items is subject to an information barrier. In response to determining 615 the set of content items is subject to an information barrier, a further determination 620 can be made as to whether an information barrier of the archive folder matches the information barrier on the set of content. According to one embodiment, the set of content can only be saved in the archive folder if the information barrier on the archive folder matches the information barrier on the set of content items.

In response to determining 615 the set of content items is not subject to an information barrier or determining 620 that the information barrier of the archive folder matches the information barrier on the set of content, the located 610 content items in the set of content items and associated metadata can be saved 625 to the archive folder. User collaborations on the content items in the set of content items can be backed up 630 and a pre-archive state for each content item in the set of content items can be saved 635. Access to the user collaborations on the content items in the set of content items can then be removed 640 and each content item in the set of content items can be marked 645 as archived, e.g., with metadata associated with the content item.

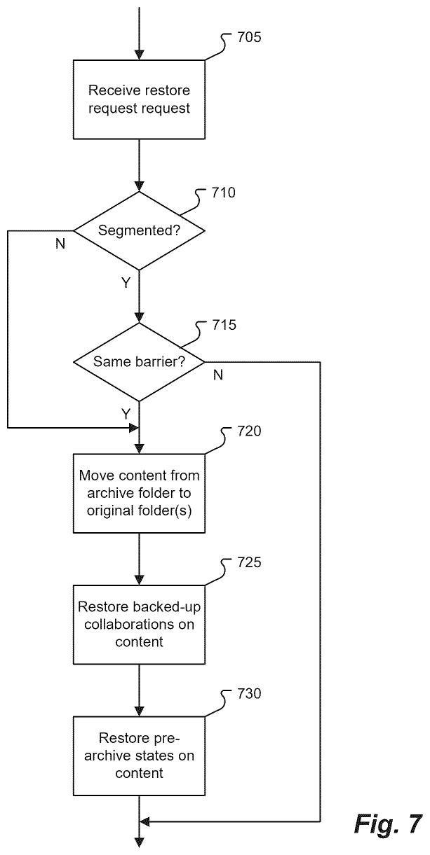

FIG. 7 is a flowchart illustrating an exemplary process for restoring content from an archive to a collaboration environment according to one embodiment of the present disclosure. As illustrated in this example, archiving content items of a cloud-based collaboration environment can further comprise receiving 705 a request to restore archived content to the cloud-based collaboration environment. The request can identify a user to which the archive is to be restored.

A determination 710 can be made as to whether the archived content is a segmented archive. In response to determining 715 the archived content is a segmented archive, a further determination can be made as to whether an information barrier on the segmented archive matches an information barrier on the user to which the archived content is to be restored. According to one embodiment, archived content can only be restored if the user has an information barrier matching the information barrier on the archived content.

In response to determining 710 the archived content is not segmented or determining 715 the information barrier on the segmented archive matches the information barrier on the user to which the archived content is to be restored, the archived content items can be moved 720 from the archive folder to an original one or more folders for the content items in the archive folder. User collaborations on each moved content items backed up at the time the content items where archived can then be restored 725. Similarly, a saved, pre-archive state on each moved content item can be restored 730.

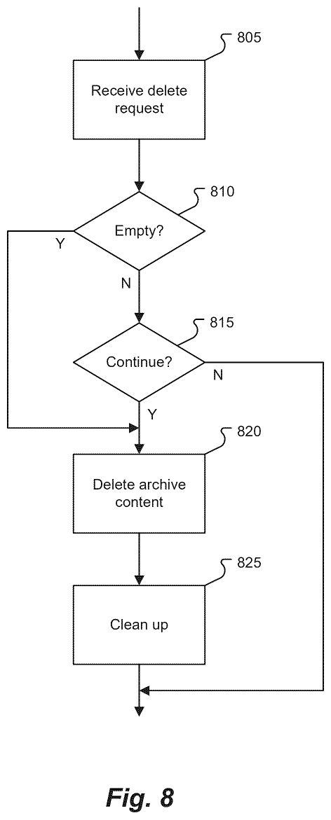

FIG. 8 is a flowchart illustrating an exemplary process for deleting an archive according to one embodiment of the present disclosure. As illustrated in this example, archiving content items of a cloud-based collaboration environment can further comprise receiving 805 a request to delete the archive folder. For example, the request can be received through an administrator user interface. In another example, the request can be generated and received automatically based on an archiving policy. Such a policy may define, for example, a period of time after which an archive should expire.

A determination 810 can be made as to whether the archive folder is empty. In response to determining the archive folder is not empty, a further determination 815 can be made as to whether to continue. For example, if the archive folder is not empty, a user, such as an administrator, can be prompted through a user interface to confirm that the archive folder should be deleted anyway.

In response to determining 810 the archive folder is empty or determining 815 to continue, the archive folder can be deleted 820. Any backed up user collaborations or saved content item states associated with the archive folder can also be cleaned up.

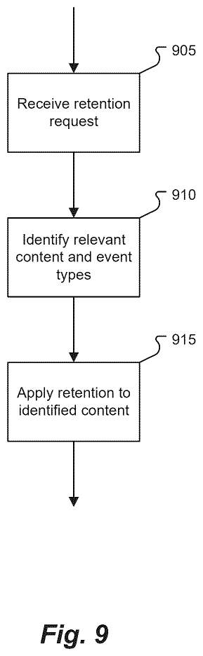

FIG. 9 is a flowchart illustrating an exemplary process for applying governance to archived content according to one embodiment of the present disclosure. As illustrated in this example, applying governance to archived content in a cloud-based collaboration environment can comprise receiving 905 a request to apply retention to a set of content items. The request to apply retention can comprise a request to retain the content, i.e., to prevent change or destruction, for various reasons. In some cases, the request to retain the content can comprise a request to place a legal hold on the content, e.g., due to actual or potential litigation. The set of content items can be stored, in whole or in part, in an archive.

The set of content items or a user associated with the set of content can be identified 910. As will be described, the content items can be identified 910 by name of a content item or by activity of a user. One or more retention markers can be applied 915 based on the identified set of content items or a user associated with the set of content. The retention markers can comprise metadata indicating that the content should be retain or is subject to a legal hold.

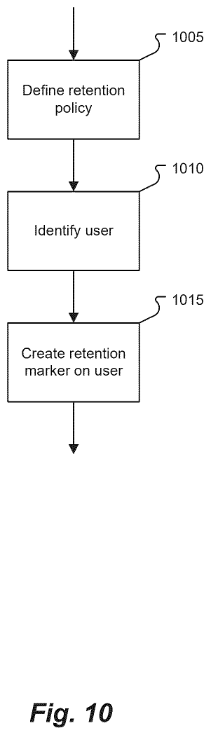

FIG. 10 is a flowchart illustrating an exemplary process for retaining currently owned content according to one embodiment of the present disclosure. As illustrated in this example, retaining currently owned content can comprise defining a retention policy for the content. The policy can define, for example, a time period for which the content should be retain, conditions for when the content no longer needs to be retained, etc. A user who currently owns the content can be identified 1010 and a retention marker can be applied to the user to indicate that content owned by this user is subject to a retention policy.

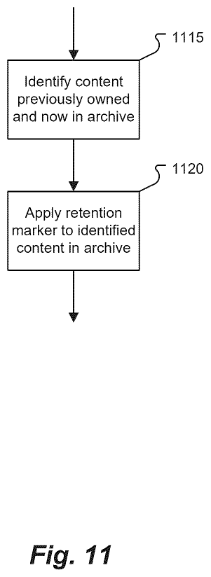

FIG. 11 is a flowchart illustrating an exemplary process for retaining previously owned content according to one embodiment of the present disclosure. As noted above, the request to apply retention to the set of content items can identify a user. Therefore, identifying each content item of the set of content items can comprise identifying 1115 content items in the archive previously owned by the identified user. Once identified, a retention marker can be applied to each content item in the set of content items in the archive.

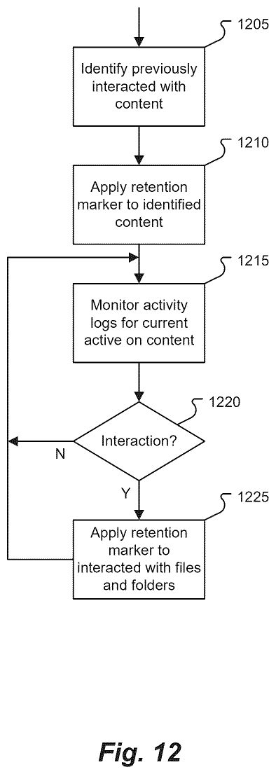

FIG. 12 is a flowchart illustrating an exemplary process for applying an activity-based legal hold on archived content according to one embodiment of the present disclosure. As illustrated in this example, applying an activity-based legal hold on archived content can comprise identifying 1205 content items the user previously interacted with. Identifying 1205 content items the user previously interacted with can comprise identifying content items the user previously opened, previewed, edited, downloaded, or moved to trash. Retention markers can then be applied 1210 to each identified content item in the archive.

One or more activity logs of the cloud-based collaboration environment can then be monitored 1215 for ongoing activity or the user. A determination 1220 can be made as to whether the user has interacted with any active content items in the cloud-based collaboration environment. In response to determining 1220 the user has interacted with an active content item in the cloud-based collaboration environment, a retention marker identifying the legal hold to the active content item can be applied 1225 to the content item the user has interacted with.

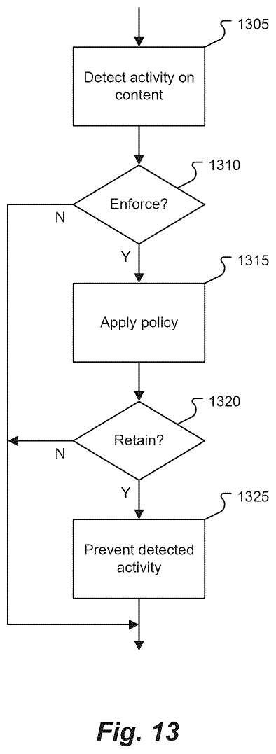

FIG. 13 is a flowchart illustrating an exemplary process for enforcement of retention according to one embodiment of the present disclosure. As illustrated in this example, enforcement of retention can comprise detecting an activity on a content item of the collaboration environment and determining 1310 whether to apply a retention policy based on the detected activity. The activity can comprise a move of the content item, a transfer of ownership of the content item, or destruction of the content item. Determining 1310 whether to apply a retention policy can be based on retention markers on the content item or a user involved in the activity.

In response to determining 1310 to apply the retention policy, the retention policy can be applied and a further determination 1320 can be made as to whether to retain the content item based on the applied retention policy. In response to determining to retain the content, the requested activity can be prevented 1325, i.e., blocked or denied.

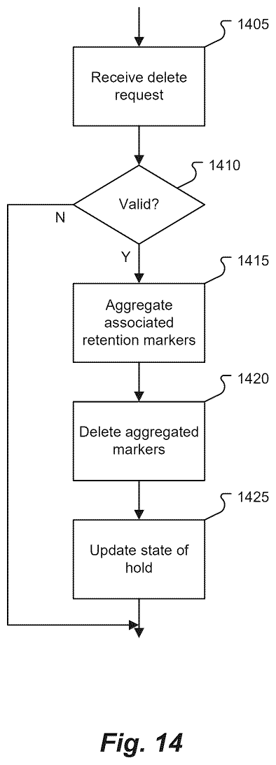

FIG. 14 is a flowchart illustrating an exemplary process for removing a legal hold according to one embodiment of the present disclosure. As illustrated in this example, removing a legal hold receiving 1405 a request to remove the legal hold and determining 1410 whether the request to remove the legal hold is valid. In response to determining 1410 the request to remove the legal hold is valid, associated retention markers identifying the legal hold can be aggregated 1415, the aggregated retention markers can be deleted 1420, and a state of the legal hold can be updated 1425 to indicate it is no longer active.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease andlor reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for applying governance to archived content in a cloud-based collaboration environment, the method comprising:
archiving, by a processor of the cloud-based collaboration environment, a set of content items, wherein archiving the set of content items comprising changing ownership of the set of content items without changing a storage location of the set of content items;
receiving, by the processor of the cloud-based collaboration environment, a request to apply retention to the set of content items,
identifying, by the processor of the cloud-based collaboration environment, the set of content items or a user associated with the set of content; and
applying, by the processor of the cloud-based collaboration environment, one or more retention markers based on the identified set of content items or a user associated with the set of content.

2. The method of claim 1, wherein the request to apply retention to the set of content items identifies a user and wherein identifying each content item of the set of content items comprises identifying content items in the archive previously owned by the identified user.

3. The method of claim 2, further comprising defining a retention policy related to the user and applying a retention marker to the user.

4. The method of claim 1, wherein the request to apply retention to the set of content items identifies a content item by name.

5. The method of claim 4, wherein content items are stored in the archive in a hierarchical arrangement and wherein identifying each content item of the set of content items comprises traversing the hierarchy of content items in the cloud-based collaboration environment to locate all subfolders can content items therein.

6. The method of claim 1, further comprising:
detecting, by the processor of the cloud-based collaboration environment, an activity on a content item of the collaboration environment;
determining, by the processor of the cloud-based collaboration environment, whether to apply a retention policy based on the detected activity.

7. The method of claim 6, further comprising:
in response to determining to apply the retention policy, applying, by the processor of the cloud-based collaboration environment, the retention policy;
determining, by the processor of the cloud-based collaboration environment, whether to retain the content item based on the applied retention policy; and
in response to determining to retain the content, copying, by the processor of the cloud-based collaboration environment, preventing the requested activity.

8. A system comprising:
a processor; and
a memory coupled with and readable by the processor and storing therein a set of instructions which, when executed by the processor, causes the processor to:
archive a set of content items, wherein archiving the set of content items comprising changing ownership of the set of content items without changing a storage location of the set of content items;
receive a request to apply retention to the set of content items;
identify the set of content items or a user associated with the set of content; and
apply one or more retention markers based on the identified set of content items or a user associated with the set of content.

9. The system of claim 8, wherein the request to apply retention to the set of content items identifies a user and wherein identifying each content item of the set of content items comprises identifying content items in the archive previously owned by the identified user.

10. The system of claim 9, wherein the instructions further cause the processor to define a retention policy related to the user and applying a retention marker to the user.

11. The system of claim 8, wherein the request to apply retention to the set of content items identifies a content item by name.

12. The system of claim 11, wherein content items are stored in the archive in a hierarchical arrangement and wherein identifying each content item of the set of content items comprises traversing the hierarchy of content items in the cloud-based collaboration environment to locate all subfolders can content items therein.

13. The system of claim 8, wherein the instructions further cause the processor to:
detect an activity on a content item of the collaboration environment;
determine whether to apply a retention policy based on the detected activity.

14. The system of claim 13, wherein the instructions further cause the processor to:
in response to determining to apply the retention policy, apply the retention policy;
determine whether to retain the content item based on the applied retention policy; and
in response to determining to retain the content, prevent the requested activity.

15. A non-transitory, computer-readable medium comprising a set of instructions stored therein which, when executed by a processor, causes the processor to:
archive a set of content items, wherein archiving the set of content items comprising changing ownership of the set of content items without changing a storage location of the set of content items;
receive a request to apply retention to the set of content items;
identify the set of content items or a user associated with the set of content; and
apply one or more retention markers based on the identified set of content items or a user associated with the set of content.

16. The non-transitory, computer-readable medium of claim 15, wherein the request to apply retention to the set of content items identifies a user and wherein identifying each content item of the set of content items comprises identifying content items in the archive previously owned by the identified user and wherein the instructions further cause the processor to define a retention policy related to the user and applying a retention marker to the user.

17. The non-transitory, computer-readable medium of claim 15, wherein the request to apply retention to the set of content items identifies a content item by name.

18. The non-transitory, computer-readable medium of claim 17, wherein content items are stored in the archive in a hierarchical arrangement and wherein identifying each content item of the set of content items comprises traversing the hierarchy of content items in the cloud-based collaboration environment to locate all subfolders can content items therein.

19. The non-transitory, computer-readable medium of claim 15, wherein the instructions further cause the processor to:
detect an activity on a content item of the collaboration environment;
determine whether to apply a retention policy based on the detected activity.

20. The non-transitory, computer-readable medium of claim 19, wherein the instructions further cause the processor to:
in response to determining to apply the retention policy, apply the retention policy;
determine whether to retain the content item based on the applied retention policy; and
in response to determining to retain the content, prevent the requested activity.
